(19) United States
(12) Patent Application Publication
(10) Pub. No.: US 2012/0031985 A1
(43) Pub. Date: Feb. 9, 2012

(54) FAULT TOLERANT APPLIANCE

(76) Inventors: Terry Lien Do, Louisville, KY (US); Craig Nold, Louisville, KY (US)

(21) Appl. No.: 12/852,825

(22) Filed: Aug. 9, 2010

(51) Int. Cl. G05D 23/24

(52) U.S. Cl. 236/46 A

(57) ABSTRACT

A method for controlling an appliance includes detecting a fault state of the appliance, determining that the fault state is associated with a monitoring sensor of the appliance, and changing an operational mode of a system of the appliance associated with the monitoring sensor to a time-based operational mode.

### BACKGROUND OF THE INVENTION

The aspects of the disclosed embodiments generally relate to appliances such as air conditioning systems. More particularly, the aspects of the disclosed embodiments relate to fault indication handling in an air conditioning system.

Air conditioning systems, such as room air conditioners for example, typically utilize thermistors to detect ambient air temperature. A thermistor will have known calibrated values that correlate to the actual or measured air temperature. Examples of the uses of thermistors in air conditioning systems can include detecting the room or air conditioning compartment ambient air temperature, which allows the room air conditioner to control and cycle the compressor or other systems of the room air conditioner on and off to maintain the desired room temperature. In an evaporator, a thermistor is typically used to monitor a temperature of the evaporator coil in order to control a temperature based defrost cycle and remove any accumulated ice from the evaporator coils.

In the event of a thermistor failure, such as for example, an open circuit, a short circuit, an out of tolerance range indication, or a general drill of thermistor values over time, a thermistor fault is detected and the air conditioning system will typically shut down in order to protect the components of the air conditioning system from damage. In some cases, a fault message or other error code may be displayed on a control panel of the air conditioning system. However, disabling the functionality of the air-conditioning system due to a thermistor fault can be inconvenient, particularly when aspects of the system may still be operational. It would be advantageous to be able to detect a fault in an air conditioning system and modify an operational cycle of the system in order for the system to continue to operate.

Accordingly, it would be desirable to provide a system that addresses at least some of the problems identified above.

### BRIEF DESCRIPTION OF THE INVENTION

As described herein, the exemplar embodiments overcome one or more of the above or other disadvantages known in the art.

One aspect of the exemplary embodiments relates to a method for controlling an appliance. In one embodiment the method includes detecting a fault state of the appliance, determining that the fault state is associated with a monitoring sensor of the appliance, and changing a sensor-based operational mode of a system associated with the monitoring sensor to a time-based operational mode.

Another aspect of the disclosed embodiments relates to an appliance. In one embodiment, the appliance includes an air cooling system a controller for controlling an operational cycle of the air cooling system, a sensor coupled to the cooling system for providing operation data on the air cooling system to the controller, a fault detector coupled to the controller, the fault detector configured to detect a fault state related to the sensor, and wherein the controller is configured to change a sensor-based operational cycle of the air cooling system to a time-based operational cycle upon detection of the fault state.

These and other aspects and advantages of the disclosed embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended conceptually illustrate the structures and procedures described herein. In addition, any suitable size, shape or type of elements or materials could be used.

### BRIEF DESCRIPTION OF THE DRAWINGS

FIGS. 1a, 1b, 2a and 2b are schematic illustrations of exemplary appliances incorporating aspects of the disclosed embodiments;

FIG. 3 is a schematic illustration of a portion of an exemplary control system of the appliance in FIGS. 1a and 2a in accordance with an exemplary embodiment; and

FIG. 4 is a flowchart of a process incorporating aspects of the disclosed embodiments.

### DETAILED DESCRIPTION OF THE EXEMPLARY EMBODIMENTS OF THE INVENTION

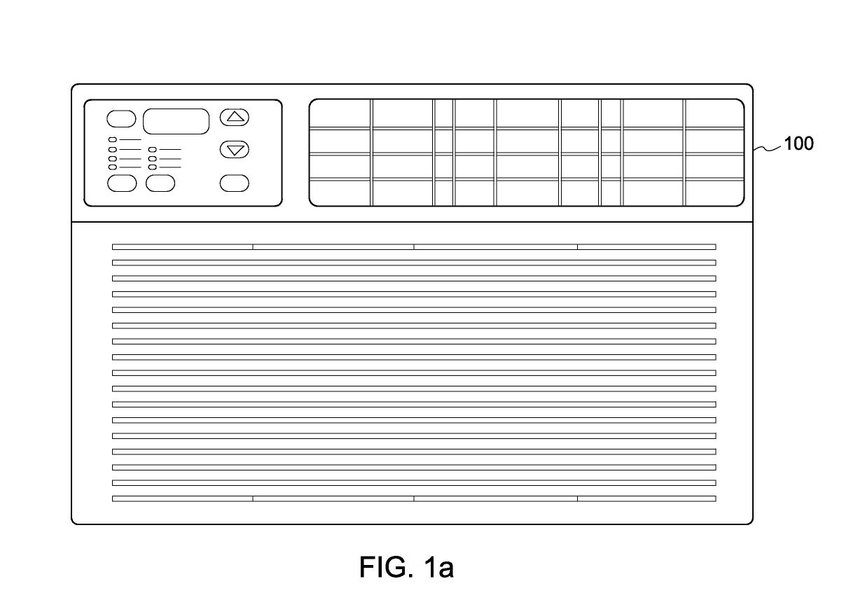

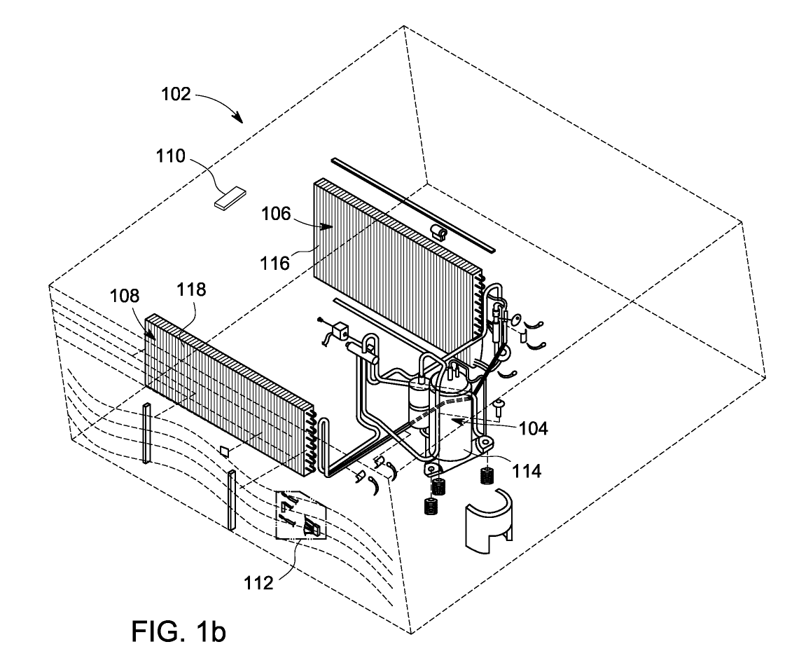

FIG. 1a illustrates an exemplary appliance 100 incorporating aspects of the disclosed embodiments. In this example, the appliance 100 is shown as a room air conditioner, but in alternate embodiments the appliance 100 may be, for example, any suitable appliance that includes an air cooling or refrigeration system.

As shown in FIG. 1b, the appliance 100 generally includes an air cooling or conditioning system 102 that includes a compression stage 104, a condensor stage 106 with condenser coils 116, and an evaporation stage 108. In alternate embodiments, the air cooling system 102 can include other suitable components for providing air conditioning and refrigeration. In one embodiment, the cooling system 102 can be a sealed cooling system. The air cooling system 102 includes temperature detecting devices or sensors 110 and 112 for monitoring temperatures internal to and external to the air cooling system 102. In the example of FIG. 1b, the temperature sensors 110, 112 are thermistors. Thermistor 112 in this example is used to detect the ambient temperature of the room that is being cooled by the air conditioner. The detected ambient temperature can be compared to a set point temperature of the air conditioner and is used to control the on/off cycling of the air conditioner to maintain the desired set point temperature. Thermistor 110 is coupled to the evaporation stage 108 and is used to monitor a temperature of the evaporation coils 118. If the temperature of the evaporator coils 118 falls below a predetermined limit, a defrost mode of the air conditioner is activated in order to remove any frost or ice build-up in the evaporator 108. For example, when a temperature of the evaporation stage 108 is detected to be below a pre-determined temperature setpoint, such as for example 30-degrees Fahrenheit, the compressor 114 of the compression stage 104 can be turned off. A defrost cycle can be initiated to allow the evaporator coils 118 to defrost and melt the ice build up. Once the temperature of the evaporator coils 118 are detected to be greater than or equal to another pre-determined temperature setpoint, such as for example 50-degrees Fahrenheit, defrost cycle is ended and the compression stage 104 can be allowed to turn back on. Thermistor 110 can thus be used in this fashion to initiate a temperature based defrost cycle.

In one embodiment, the defrost cycle can be a time-based defrost cycle. When the temperature of the evaporator coils 118 are detected to be below a pre-determined temperature setpoint, such as for example 30 degrees Fahrenheit, the compressor 114 of the compression stage 104 is turned off for a pre-determined time interval, such as ten minutes. After the time interval elapses, the compression stage 104 comes back on. The temperature of the evaporation stage 108 is not monitored during this time interval and, in this example, the defrost cycle is based on time.

Although only two thermistors 110, 112 are shown in FIG. 1b, the appliance 100 can include any suitable number of temperature detecting sensors or thermistors. Additionally, the temperature sensors can include any suitable temperature sensor other than including a thermistor, which are suitably located within the air cooling system 102. For example, the temperature sensor can include a thermocouple, a resistance temperature device or an integrated circuit sensor.

The aspects of the disclosed embodiments allow for an appliance 100, such as the air conditioner 102, to continue to operate even when a fault related to one of the temperature sensing devices 110, 112 is detected, without the risk of damage to the appliance 100. The term “fault” as used herein will generally describe a problem with or malfunction of the thermistor, that does not allow the thermistor to operate normally. A fault can include for example, an open circuit condition, a short circuit condition, or an out of tolerance condition. An open circuit condition is one in which a resistance reading across the thermistor 110 is near infinity or out of the range that the measuring device can read. An example of such a condition is where the thermistor 110 is disconnected, a contact lead is broken or the circuit inside the thermistor 110 has opened. Although a resistance measurement is described, the measurement could also include a suitable voltage or current measuring device.

A short circuit condition is one in which a resistance measurement across the thermistor 110 is at or near zero, indicating the lack of any functional resistance element in or across the thermistor 110. In one embodiment, this can be detected by measuring resistance, voltage or current associated with the thermistor 110 or circuit.

An out of tolerance condition is one in which the values or measurements provided by the thermistor 110 are determined to not be in compliance with the stated specifications for the thermistor 110. Each thermistor 110 has a corresponding data sheet that specifies a resistance value that corresponds to a temperature value. Tin measured resistance value is outside of the range, this could be categorized as a fault. This can due to man factors, including drift over time or component failure.

For example, in one embodiment, when a fault related to a temperature sensing device 110, 112 is detected, the operation of the system of the appliance 100 monitored by the faulty temperature sensing device is controlled to operate in a time-based mode, rather than a temperature based mode. This allows the appliance 100 to continue to operate in a modified manner when the detected fault is not critical to the operation of the appliance 100

As an example, in the event that the room temperature thermistor 112 is not operating normally, the room air conditioner 102 will not be able to detect the ambient air temperature of the room that it is cooling. This creates a fault situation because the set temperature cannot be met. If, at the time of the fault of the room temperature thermistor 110, the set temperature is less than the room temperature, and the compressor stage 104 is running in order to cool the room, the potential exists that the compressor stage 104 will continue to run without turning or cycling off. If at the time of the fault the set temperature was greater than the room temperature, the compressor stage 104 may not turn on, as there will be no detected call for cooling from the cooling syStem 102. However, the detected fault is not determined to be a critical fault because continued operation of the air conditioner 102 in a time-based mode will not necessarily result in damage to the air conditioner 102, since the air conditioner 102 can be cycled on and off in a time based mode, rather than a temperature based mode. In accordance with the aspects of the disclosed embodiments, in this situation, the control of the cooling system 102 or compressor stage 104 can be cycled between on and of states based on time and not temperature. The on and off tune periods can be any suitable time periods that allows the appliance 100 to operate without the risk of damage or performance degradation.

in one embodiment, the on and off time periods can be for example, 20 minutes on and 20 minutes off. In alternate embodiments, any suitable timed duty cycle can be used. The on and off time periods do not have to be equal. A time-based operating cycle allows the appliance 100 to continue to provide cooling when the room ambient air temperature cannot be monitored relative to the set temperature.

Referring again to FIG. 1b, if a fault is detected relating to the evaporator thermistor 110, the appliance 100 will lose the ability to control a temperature based defrost cycle. As noted herein, the temperature of the evaporator coils 118 can be used to initiate a defrost cycle. If the evaporator thermistor 110 is not working or has malfunctioned, the failure to initiate a defrost cycle or the continuous operation of the defrost heater can be detrimental to the functioning and performance of the appliance. If a fault is detected with respect to the evaporator thermistor 110, in this situation, the appliance 100 can switch to a time-base defrost cycle, where a time-based duty cycle is applied to the defrost cycle. The duty cycle of this time-base defrost can be one that is pre-determined fbr the particular air cooling system 102 or is based on a prior defrost cycle history stored by the appliance 100.

For example, in one embodiment, the cooling and defrost operational cycles can be stored by the appliance 100. When a fault is detected and the affected system identified, the duty cycle of the time-based operational mode can be based on the most recent operational history.

If the fault relates to both the evaporator thermistor 110 and the room temperature thermistor 112, the appliance 100 can enter a hybrid operating mode. In this situation the appliance 100 can have a set cycle time for the compressor 104 and a run on time-based defrost cycle.

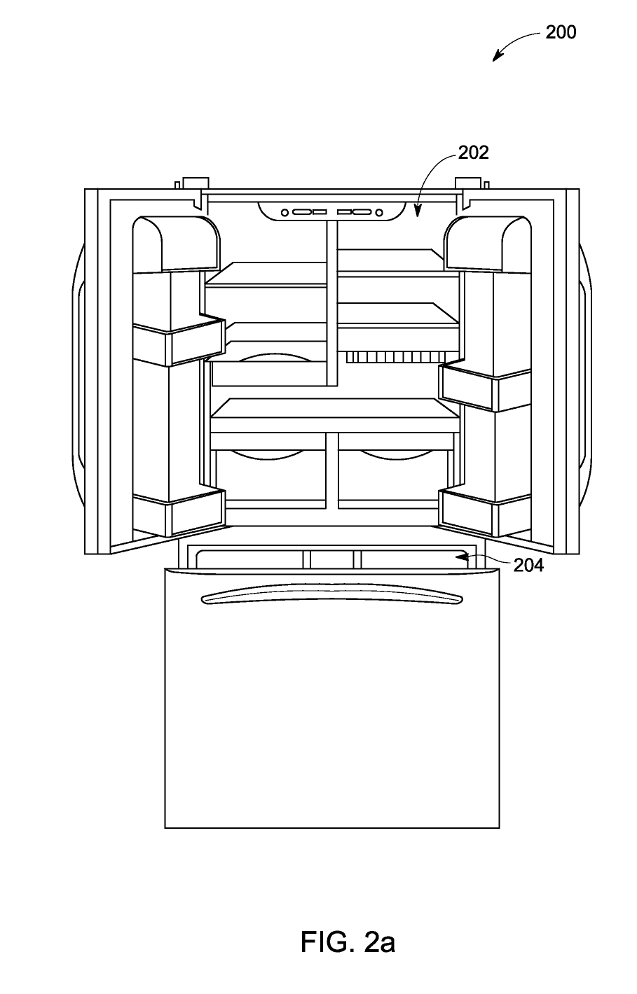

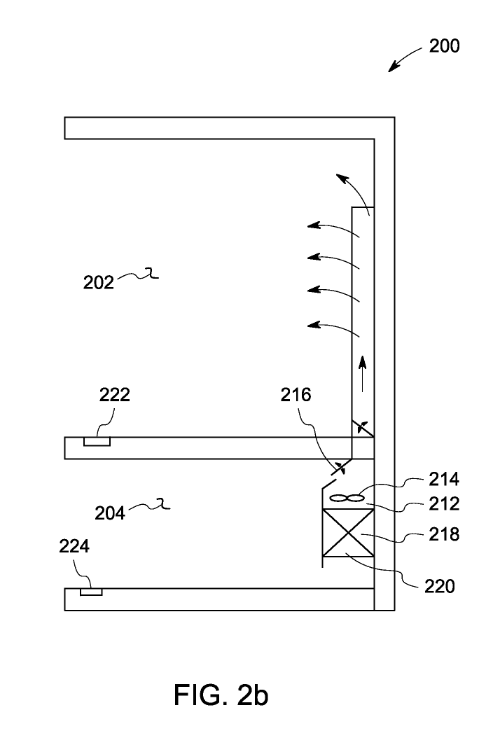

FIG. 2a illustrates another exemplary appliance 200 incorporating aspects of the disclosed embodiments. In this embodiment, the appliance 200 is a refrigerator unit or other such refrigeration or freezer unit. In this example, the refrigerator unit 200 includes a first or upper compartment 202 and a second or lower compartment 204. In one embodiment, the upper compartment 202 can be for fresh foods, while the lower compartment 204 may normally function as a freezer compartment. The arrangement, number and type of compartments is not limiting as to the aspects of the present disclosure.

As shown in FIG. 2b, an evaporator 218 is disposed in a sub-compartment 212 to provide cool air for the compartments 202 and 204. The refrigerator 200 also includes a fan 214 in the sub-compartment 212 for circulating or directing the refrigerated air to the upper compartment 202 and the lower compartment 204. The refrigerator 200 also includes a damper 216 for controlling the flow of refrigerated air from the sub-compartment 212 to the compartments 202, 204. The evaporator 218 can be operatively connected to a common compressor (not shown), as is known in the art.

in this example, the refrigeration unit 200 includes three temperature detection sensors 220, 222, and 224, which in this example are thermistors. Sensor 220 is coupled to the evaporator 218 for monitoring a temperature of the evaporator coils. If the temperature of the evaporator coils reaches a pre-determined temperature, a defrost cycle can be initiated. Sensor 222 monitors a temperature of compartment 224, while sensor 224 monitors a temperature of compartment 206. The sensors 222 and 224 provide temperature signals that are used to control the temperature of each of the respective compartments in a manner that is generally known. The particular number and location of each of the sensors 220, 222 and 224 is merely exemplary, and in alternate embodiments any suitable number of sensors can be used and the sensors can be mounted in suitable locations of the appliance 200.

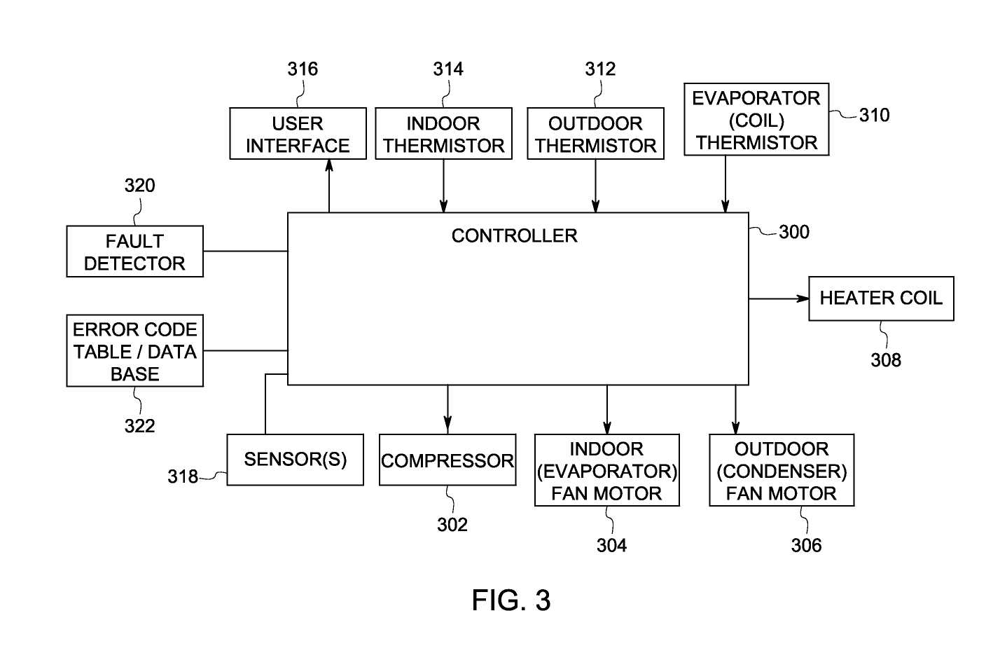

FIG. 3 illustrates one example of a control system or controller 300 for an appliance 100 incorporating aspects of the disclosed embodiments. In this example, the controller 300, which can also be referred to as, or be couple to a computer, is generally configured to control the operation and functions of the various components of the appliance 100, including determining a fault condition related to a temperature sensing device and switching an operation of the affected system to a time based operational cycle. Some of the components that are coupled to and/or controlled by the controller 300 can include, but are not limited to, compressor 302, evaporator fan motor 304, condenser fan motor 306, heater coil 308 and user interface or control 316. In this example, three temperature monitoring sensors 310, 312, 314 are coupled to the controller 300. The controller 300 is configured to receive data from each of the evaporator coil thermistor 310, the outdoor thermistor 312 and the indoor thermistor 314, including any fault indications. Upon detecting a fault condition related to one of the thermistors 310, 312, 314, the controller 300 can switch an operational cycle of the affected cooling system 102 component from a temperature based mode to a time-based mode, as described herein. In one embodiment, the controller 300 can include a fault detector 320. The fault detector 320 can be configured to monitor the operation of the thermistors 310, 312 and 314 and detect a fault condition as referred to above. The fault detector 320 can provide a suitable fault signal or indication to the controller 300. As noted above, a thermistor fault is generally indictated by detection of an open circuit a short circuit or out-of-range or tolerance condition. In one embodiment, the fault detector 320 can comprise a voltage, current or impedance measuring device or circuit that is used to detect one or more, or a combination of the above-mentioned fault indicators. In alternate embodiments, the fault detector 320 can comprise any suitable device to detect a thermistor fault.

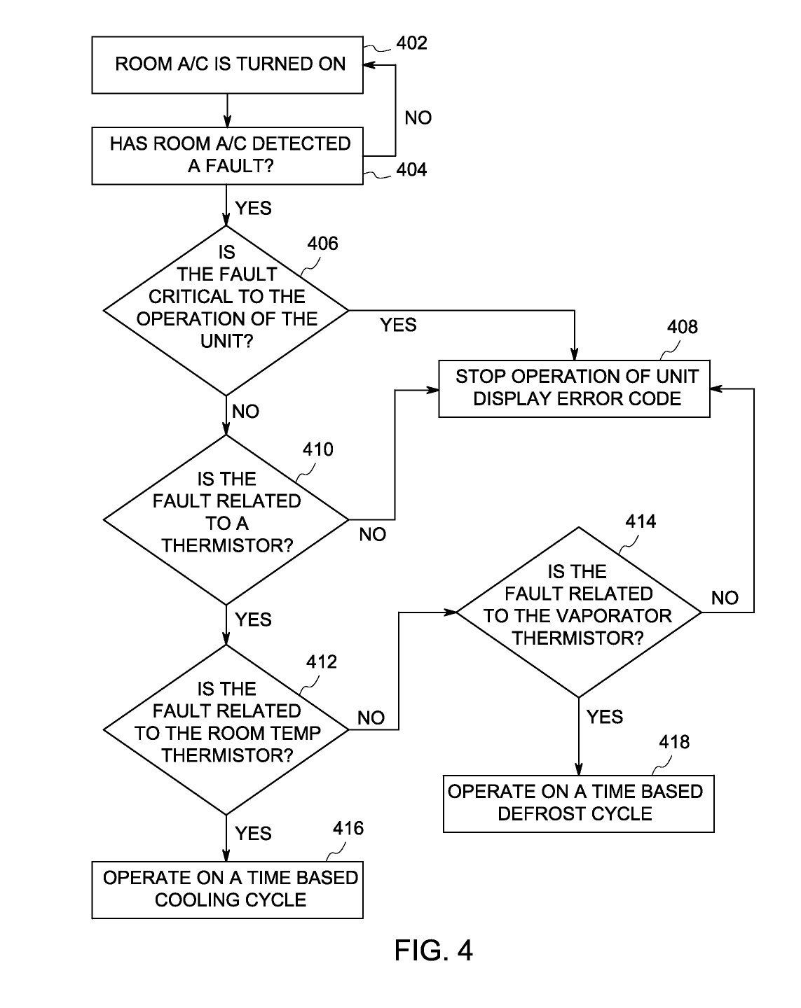

FIG. 4 illustrates a flowchart of an exemplary process incorporating aspects of the disclosed embodiments. In this example, the appliance 100 is powered on 402. In one embodiment, the operational state of the appliance 100 is in a “Cool” mode or setting. A determination 404 is made as to whether a fault is detected by the controller 300, if there is no fault detected, the appliance 100 is allowed to continue in its normal or the set operational state. If a fault is detected, it is determined 406 whether the fault is critical to the operation of the appliance 100. If the fault is critical to the operation of the appliance, the operational state of the appliance is set 408 to a power off or such other suitable standby state where 110 further damage is caused to the appliance. A fault that is critical to the operation of the appliance generally means that continued operation of the appliance 100 in this fault state will result in further damage or catastrophic failure of the appliance 100. In one embodiment, a fault message or other suitable error code can be communicated via the user interface 316 of the appliance 100. An example of a critical fault would be a situation in which the refrigerant coolant in a sealed system has leaked out to a point where the air conditioner cannot provide any cooling. Exemplary methods of detecting this type of situation can include pressure sensor in the refrigerant lines as well as monitioring the ambient air temperature to a run time of the appliance 100. Pressure sensors installed in the system can be used to monitor the pressure in the lines. If the pressure is too low or too high, a corresponding error indication and code can be generated. When monitoring the run time and ambient temperature, if the run time, as monitored by a suitable timer device, is determined to exceed, a pre-determined time period without a suitable or expected change or decrease in temperature, a corresponding error indication and code is generated. In one embodiment, referring to FIG. 3, a table or database 322 can be maintained that stores the association of error states, codes, and fault values, and can be used to determine whether an error is a critical fault or non-critical fault.

Upon determining that the fault is not critical to the operation of the appliance 100, it is determined 410 whether the fault relates to a temperature sensor or thermistor, if the fault is not related to a thermistor, the operational state of the appliance is powered off or set to a suitable standby state 408. In one embodiment, where sensors other than temperature sensors are used to monitor operational aspects of the appliance 100, a suitable logic flow can be applied to determine if the fault is such that modified operation of the appliance is permitted.

if the fault is related to a thermistor, a determination 412, 414 is made as to which thermistor in the appliance 100 has generated the fault indication. If the fault relates to a room temperature thermistor 112, the appliance 100 changes 416 the operating cycle of the cooling system 102 to a time based mode. If the fault is related to an evaporator thermistor 110, the operation of the evaporator system 108 is controlled 418 to operate in a time based defrost cycle mode.

In one embodiment, the time-based operation 416 of the appliance 100 can be based on a comparison of the last known temperature set point and the last known room temperature prior to the fault. After a fault related to the room temperature thermistor 112 is detected 412, a comparison is made between the temperature set point and the room temperature measurement just prior to the fault. In one embodiment, the controller 300 stores the temperature set point values and measured room temperature values in a suitable memory location, such as a look-up table. Based on a determined relationship between the last known temperature set point and the last known room temperature, a suitable, time-based operational mode can be established. For example, if the difference between the last known set temperature and the last known room temperature is below a predetermined value, where the set temperature is below the room temperature, a lower cycle time can be set than if the difference is greater than the predetermined value.

In alternate embodiments, any suitable cooling strategy or algorithm can be utilized. For example, the time-based operation 416 can also take into account the time of day, such as daytime and nighttime. During nighttime operation, the required cooling temperature may be less than during the daytime hours, since typically, the ambient air temperature during the day can be warmer than at night. Thus, less cooling may be required during nighttime operation. In one embodiment, the time-based operation 416 could have fewer on/off cycles than during the day.

As another example, in a situation where the last known set temperature is above the last known room temperature, meaning that the room is cooler than the set temperature, the time-based operation 416 of the cooling cycle might be minimized. In this embodiment, a comparison is made between the last known set temperature and the last known measured room temperature. If the last known measured room temperature is less than the last known set temperature, the time-based operation 410 is set to a minimum value, such as a cooling cycle that has longer off period than the on period. For example, where a normal time-based operation 416 can be 20 minutes of cooling on and 10 minutes of cooling off, a minimized cooling cycle can be 10 minutes of cooling on and 20 minutes of cooling off.

Although the aspects of the disclosed embodiments are generally described herein with respect to cooling, in alternate embodiments, the aspects of the disclosed embodiments can also be applied to heating. For example, certain air conditioning units include a reversing valve to reverse the direction of the refrigerant in the sealed system, allows the system to circulate hot air instead of cold air that are capable of providing a heating function. Other heating units, such as for example a heat pump, may also utilize aspects of the disclosed embodiments. In those situations, a suitable heating cycle can be implemented, in a manner similar to that described above, to provide heating as required in the event of a detected fault.

The aspects of the disclosed embodiments are not limited to temperature sensors or thermistors. Other types of sensors, detectors and diagnostics can be incorporated as well. For example, as shown in FIG. 3, one or more sensors 31 can optionally be included and coupled to the controller 300. In one embodiment, the sensor 318 is a pressure sensor that monitors sealed system or line pressures. If a fault is detected related to the pressure sensor 318, the fault can be interpreted and the operating mode of the appliance 100 changed to accommodate the detected fault.

The aspects of the disclosed embodiments may be implemented in software, hardware, application logic or a combination of software, hardware and application logic. The software, application logic and/or hardware may reside on a processor, controller or computer readable medium or different portions thereof. In the context of this document a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

The aspects of the disclosed embodiments may also include software and computer programs incorporating the process steps and instructions described above that are executed in one or more computers. In one embodiment, one or more computing devices, such as a computer or the controller 300 of FIG. 3, are generally adapted to utilize program storage devices embodying machine readable program source code, which is configured to cause the computing devices to perform the method steps of the present disclosure. The program storage devices incorporating, features of the present invention may be devised, made and used as a component of a machine utilizing optics, magnetic properties and/or electronics to perform the procedures and methods of the present disclosure. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks, flash drive devices and semiconductor materials and chips.

The computing devices may also include one or more microprocessors for executing stored programs. The computing device may include a data storage device for the storage of information and data. The computer program or software incorporating the processes and method steps incorporating features of the present disclosure may be stored in one or more computers on an otherwise conventional program storage device.

The aspects of the disclosed embodiments allow an appliance, such as an air conditioner or refrigeration unit, to detect thermistor faults and still be able to function without significant performance degradation. When a fault is detected with respect to a sensor such as a thermistor, an operation of the particular system normally controlled as a function of temperature sensed by the thermistor can be switched from a temperature-based mode to a time-based mode. Thus, a single point fault may not render the appliance inoperable, unless the fault is catastrophic.

Thus, while there have been shown and described and pointed out fundamental novel features of the invention as applied to the exemplary embodiments thereof, it will be understood that various omissions and substitutions and changes in the form and details of devices illustrated, and in their operation, may be made by those skilled in the art without departing from the spirit of the invention. For example, it is expressly intended that all combinations of those elements and/or method, steps which perform substantially the same function in substantially the same way to achieve the same results are within the scope of the invention. Moreover, it should be recognized that structures and/or elements and/or method steps shown and/or described in connection with any disclosed final or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for controlling an appliance, comprising:
detecting a fault state of the appliance
determining that the fault state is associated with a monitoring sensor of the appliance; and
changing a sensor-based operational mode of a system of the appliance associated with the monitoring sensor to a time-based operational mode.

2. The method of claim 1, wherein the system is an air conditioning system and the monitoring sensor comprises an ambient air temperature detector and an evaporator thermistor.

3. The method of claim 2, further comprising, when the faith state is associated with the evaporator thermistor, changing a temperature-based defrost cycle to a time-based defrost cycle.

4. The method of claim 2, further comprising, when the fault state is associated with both the ambient air temperature detector and the evaporator thermistor, changing a cooling cycle of the air conditioning system from a temperature-based cooling cycle to a time-based cooling cycle, and, changing a temperature-based defrost cycle to a time-based defrost cycle.

5. The method of claim 2, further comprising, when the fault state is associated with the ambient air temperature detector, changing a cooling cycle of the air conditioning system from a temperature-based cooling cycle to a time-based cooling cycle.

6. The method of claim 5, further comprising cycling an operation of a compressor associated with the air conditioning system between a pre-determined on-state and a pre-determined off-state.

7. The method of claim 5, further comprising:
determining a relationship between a last known temperature set-point and a last known room temperature; and
cycling an operation of the air conditioning system between a pre-determined on-state and a pre-determined off-state, where a time period for the pre-determined on-state and a time-period for the pre-determined off state is based on the relationship between the last known temperature set-point and the last known room temperature.

8. The method of claim 1, wherein the appliance is an air-conditioning system, a refrigerator unit, a heat pump, a dehumidifier unit or a freezer unit.

9. The method of claim 1, wherein the appliance is a refrigerant based compressor cooling system.

10. The method of claim 1, further comprising determining that the fault state corresponds to a failure mode that is critical to an operation of the appliance and enabling a power off state of the appliance.

11. The method of claim 2, further comprising when the fault state is associated with an ambient air temperature detector, changing a heating cycle of the air conditioning system from a temperature-based heating cycle to a time-based heating cycle.

12. An appliance comprising:
an air conditioning system;
a controller for controlling an operational cycle of the air conditioning system;
a sensor coupled to the air conditioning system for providing operational data for the air conditioning system to the controller; and
a fault detector coupled to the air conditioning system, the fault detector configured to detect a fault state related to the sensor.
wherein the controller is configured to change a sensor-based operational cycle of the air conditioning system to a time-based operational cycle upon detection of the fault state.

13. The appliance of claim 12, wherein the sensor is an ambient air temperature detector or an evaporator thermistor.

14. The appliance of claim 13, wherein the controller is further configured to detect a fault related to the evaporator thermistor and change a temperature-based defrost cycle to a time-based defrost cycle.

15. The appliance of claim 13, wherein the controller is further configured to detect a fault related to each of the ambient air temperature detector and the evaporator thermistor and to change a cycle of the air conditioning system from a temperature-based cooling cycle to a time-based cooling cycle, and change a temperature-based defrost cycle to a time-based defrost cycle.

16. The appliance of claim 13, wherein the controller is further configured to detect a fault related to the ambient air temperature detector and to change a compressor run cycle of the air conditioning system from a temperature-based run cycle to a time-based run cycle.

17. The appliance of claim 16, wherein the controller is further configured to determine a relationship between a last known temperature set-point and a last known room temperature, and to cycle an operation of the air conditioning system between an on-state and an off-state, where a time period for the on-state and a time-period for the off state is based on the relationship between the last known temperature set-point and the last known room temperature.

18. The appliance of claim 12, wherein the appliance is an air-conditioning system, a refrigeration unit, a dehumidifier, a heat pump or a freezer.

19. The appliance of claim 12, wherein the appliance is a refrigerant-based compressor cooling system.

20. The appliance of claim 12, wherein the controller is further configured to determine that the fault state corresponds to a failure mode that is critical to an operation of the appliance and enable a power off state of the appliance.

21. The appliance of claim 12, further comprising a compressor associated with the air conditioning system and configured to cycle between an on-state for a pre-determined time period and an off-state for a pre-determined time period.
